(19) United States
(12) Patent Application Publication
(10) Pub. No.: US 2024/0059343 A1
(43) Pub. Date: Feb. 22, 2024

(54) Collapsible Sand Sled and Wagon

(71) Applicant: Mary Kathryn Owens, Amanda, OH (US)

(72) Inventor: Mary Kathryn Owens, Amanda, OH (US)

(21) Appl. No.: 18/200,089

(22) Filed: May 22, 2023

Related U.S. Application Data
(60) Provisional application No. 63/474,434, filed on Aug. 16, 2022.

(51) Int. Cl. B62B 15/00; B62B 17/06; B62B 3/00

(52) U.S. Cl. CPC B62B 15/007; B62B 17/061; B62B 3/007

(57) ABSTRACT

A sand sled and wagon for transporting items across sandy terrain. The wagon is a metal frame, wherein the top opening portion is lined with a canvas material. The bottom portion of the wagon comprises legs and removably attached feet. The preferred embodiment of the feet attachment is flat or slightly upward-curved ski runners. The wagon can fold inwardly in an accordion style for convenient storage and transportation. This invention makes it easier and more convenient to transport multiple items across sandy terrain. This makes family trips to the beach easier and more enjoyable.

### CROSS-REFERENCE TO RELATED APPLICATIONS

Provisional Patent Application No. 63/474,434 tiling date 08/16/2022 The present application claims the benefit of priority under 35 U.S.C. § 119(e) of U.S. Provisional Application No. 63/474,434 filed on Aug. 16, 2022, by Mary Kathryn Owens, the entirety of which is hereby incorporated by reference.

### BACKGROUND OF THE INVENTION

This invention is directed to transporting items and equipment across sandy terrain Many families enjoy traveling to sandy areas, such as a beach. These trips are often for recreational purposes, wherein the families or groups intend to participate in several activities. This requires the groups to transport multiple items across the sand including towels, fishing equipment, refreshments, toys, and many other items.

The problem in the prior art is lack of options to transport the many items above across sandy terrain while reducing stress and effort of the couriers. The prior art solutions consist primarily of various bags and containers that individuals must manually carry, or wagons exclusively wheels. Although wheels work well on hard or dense surfaces, they are easily obstructed by sand, causing the user to exert extra effort to push or pull the wagon through the sand.

This invention solves the problem in the prior art by providing a wagon with flat runners. The flat runners allow the wagon to easily glide across sand. This allows users to transport items across sand without manually carrying the weight and without exerting extra effort to move obstructed wheels through the sand.

### BRIEF SUMMARY OF THE INVENTION

This invention is a foldable sand sled and wagon. The wagon is a metal frame in a rectangular shape with a top opening for storage of items. The inside portion of the metal frame where items are placed is covered in a removable canvas. The base of the frame is supported by metal legs. A handle is attached to the outside of the top open portion to allow users to pull the wagon.

The metal legs attach to various feet attachments via spring pin. A preferred embodiment is a wagon with that or slightly upward-curved ski runners attached as the feet attachment. An alternative embodiment is a wagon with wheels attached as the feet attachment.

The bottom and long sides of the metal frame are made of pieces of metal that extend and connect at diagonal trajectories, and are connected by circular means of attachment. This allows the bottom and long sides to compress inwardly like an accordion, thereby reducing the space consumed by the invention.

### BRIEF DESCRIPTION OF THE SEVERAL VIEWS OF THE DRAWINGS

FIG. 1 is a side perspective diagrammatic view of the invention.

FIG. 2 is a side-angled perspective diagrammatic view of the invention.

FIG. 3 is a fragmentary plan diagrammatic view of a wheel attachment of the invention.

FIG. 4 is a side perspective diagrammatic view of the bottom of the invention.

FIG. 5 is a side perspective diagrammatic view of the invention in a compressed configuration.

### DETAILED DESCRIPTION OF THE INVENTION

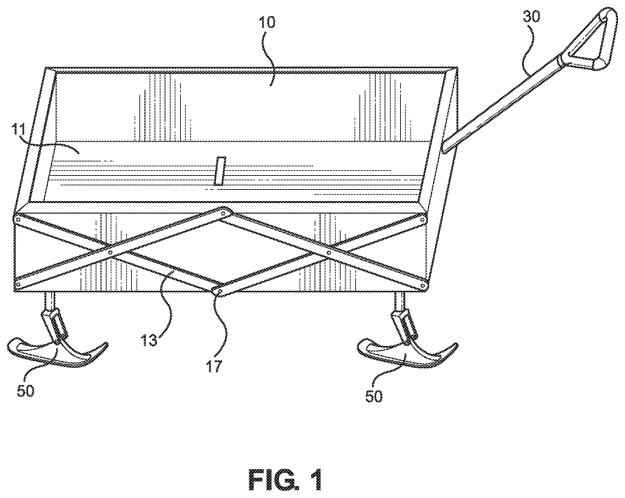

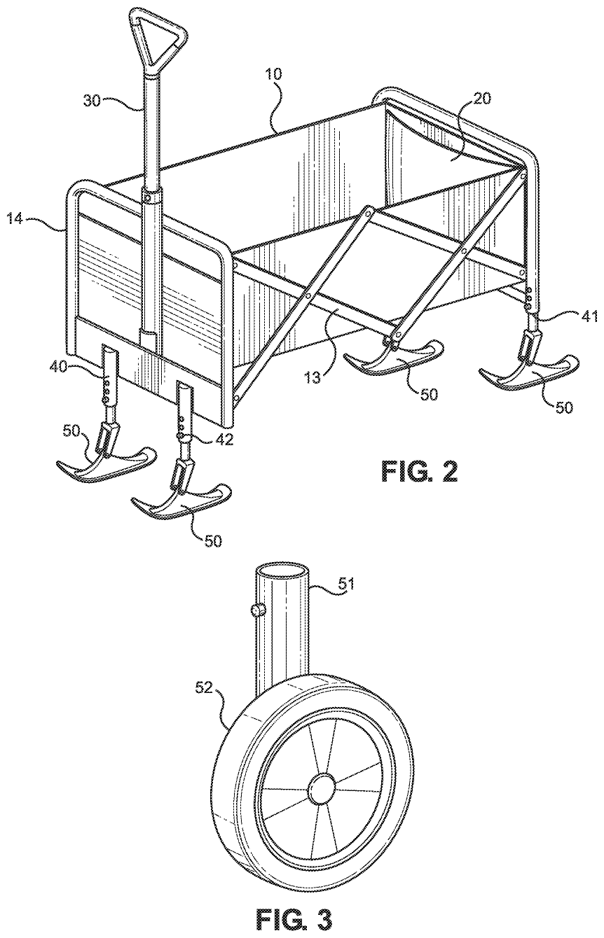

Referring now to FIG. 1 and FIG. 2 of the drawings simultaneously, there is shown a preferred embodiment of the present invention being a metal frame 10, a canvas lining 20, a handle 30, four legs 40, and four feet attachments 50.

The metal frame 10 is a composition of metal pieces creating a 3-dimensional outline of a rectangular shape with a top opening portion 11, a bottom portion 12, two long sides 13, and two wide sides 14.

The top opening portion 11 of the metal frame 10 is an opening where one of the long sides of a 3-dimensional closed rectangle would typically be.

In a preferred embodiment, the metal frame 10 has a top portion that is 16.9 inches wide and 28 inches long. The metal frame 10 has a height of 10.5 inches.

The bottom portion 12 of the metal frame 10 comprises a middle hinge piece 15 and two base portions 16. The two base portions 16 are comprised of four pieces of metal oriented across the length of the wagon. The middle hinge piece 15 is a piece of metal at the center of the bottom portion oriented across the width of the wagon. The middle hinge piece 15 allows the bottom to support weight within the canvas of the wagon while also permitting the bottom portion 12 to fold upward when collapsing the wagon for storage or transportation.

The long sides 13 of the metal frame 10 are each comprised of four rectangular pieces of metal. Each piece of metal connects to one of the wide sides 14 and extends towards the opposing wide side 14 at a diagonal trajectory. Each metal piece also connects to another metal piece from the opposing wide side 14 attachment. Due to the diagonal trajectory, the metal pieces connecting to the same wide side 14 overlap. The overlapping metal pieces are connected by circular attachment means 17 to increase the support of the metal frame 10.

Due to the diagonal trajectory and the attachment means being a single circular means of attachment 17, the long sides 13 can be folded in an accordion style by pushing the wide sides 14 inwardly towards each other.

The wide sides 14 of the metal frame 10 are generally a rectangle made of cylindrical metal. The wide sides 14 connect to the long sides 13 by means of attachment at the four corners of the wide sides 14 that face inwardly and directly towards the top opening portion 11. The bottom corners of the wide sides 14 extend downwards towards the feet attachments 50, and become the legs 40.

Each metal leg 40 is a cylindrical piece of metal that has a cylindrical opening 41 at the outermost end away from the metal frame 10. Near the cylindrical opening 53 is a pair of small holes 42 directly opposing each other.

In a preferred embodiment, the legs 40 on the sides are 24 inches apart.

Referring now to FIG. 3, a foot attachment 50 is shown. Each foot attachment 50 comprises a connective portion 51 and a bottom portion 52. The connective portion 51 is a cylindrical piece of metal with a circumference slightly less than the circumference of the cylindrical pieces of metal making up the legs 40. The connective portion of the feet attachments 51 also contains a spring pin that protrudes from two sides of the connective portion 51 and fits within the small holes 42 at the cylindrical opening 41 of the legs 40.

The bottom portion of the feet attachments 52 comprises a foot component for moving across the surface of the ground. The foot component is attached directly perpendicular to the connective portion 51.

In a preferred embodiment of the invention, the feet 50 are ski runners with a flat bottom portion. The ski runners are 4 inches in height and 6 inches in length. An alternative embodiment of the invention uses wheels as the foot attachment 50.

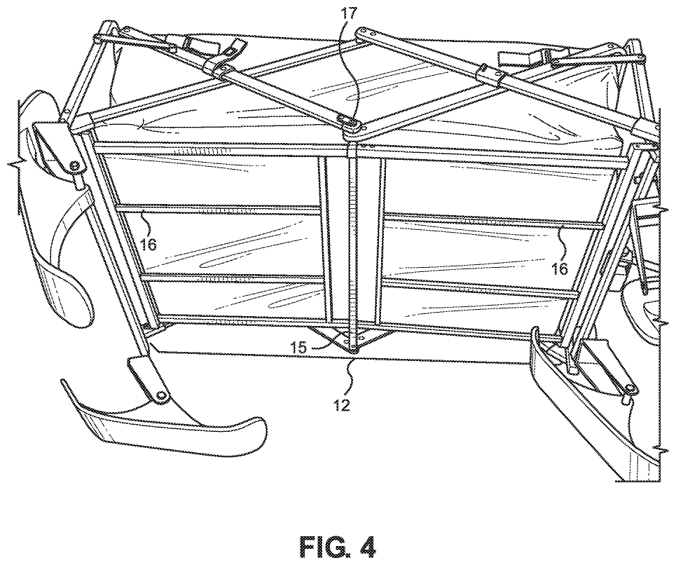

Referring now to FIG. 4, a side view of the bottom of the invention is shown.

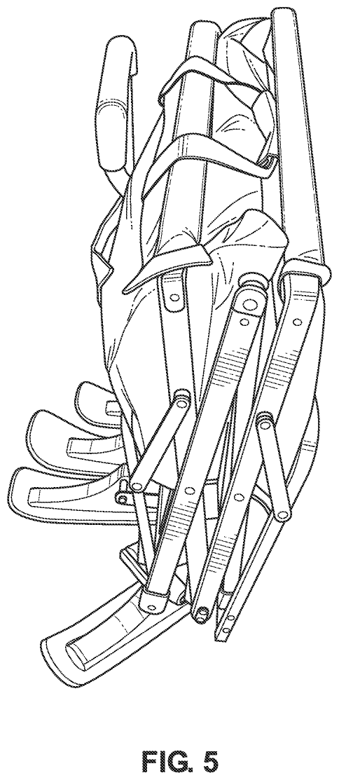

Referring now to FIG. 5, a side view of the invention in a compressed configuration is shown.

To use the invention, a user may first ensure the invention is not folded, which can be done by pulling the wide sides 14 away from each other until they stop moving further apart. The user may then insert the removable canvas 20 into the top opening 11 and attach the canvas 20 to the edges of the top opening portion 11.

If a user begins using the invention on a hard or dense surface, the user may attach the removable wheels. If the removable ski runner attachments are currently connected, the user can remove them by applying constant pressure to the spring pin of the connective portion 51 while pulling the foot attachment 50 away from the metal frame 10. Once all ski runners are removed, the user can attach the wheels by applying constant pressure to the spring pin of the connective portion 51 of the wheel attachment, inserting the connective portion 51 into the opening of the leg 41, and bringing the spring pin in line with the small holes 42 in the leg 40 so that the spring pin automatically releases and extends through the small holes 42.

The user can then place up to one hundred pounds of weight in items into the top opening portion 11 of the metal frame 10. Once finished, the user can pull the wagon by the handle 30 and travel as desired. If the user reaches sandy terrain, the user can remove the wheel attachments using the same method described above. The user can then attach the ski runner attachments using the same attachment method described above.

Once the user is finished using the invention and ready to transport or store the invention, the user may remove the feet attachments 50 as described above. The user may then remove the canvas lining 20, then apply pressure against the wide sides 14 of the metal frame 10, pressing the wide sides 14 inwardly towards each other. The invention will fold up in an accordion style, thereby reducing the amount of space consumed.

The invention claimed is:

1. A wagon, comprising:
A metal frame, having a rectangular 3-dimensional shape, and having a top opening portion and a bottom portion;
A canvas material removably attached to said metal frame;
A handle attached to one outer side of said top opening portion;
Four legs, being cylindrical metal pieces connected to the four corners of said bottom portion and extending in the opposite direction of the opening of said top portion; and
Four runners, being pieces of metal constructed in a flat or slightly upward-curved fashion perpendicularly attached to said legs.

2. A wagon as in claim 1, wherein said runners include a cylindrical piece of metal independent of said legs, and are removably attached to said legs by spring pin.

3. A wagon as in claim 1 or 2, further comprising:
Four wheels that include a cylindrical piece of metal and removably attach to said legs by spring pin.

4. A wagon as in claim 1, 2, or 3, further comprising:
The bottom and long sides of said metal frame being a composition of pieces of metal that extend at diagonal trajectories and connect by circular means of attachment, permitting the sides to compress in an accordion style.

5. A wagon as in claim 1, 2, 3, or 4, wherein the structure of said wagon can support a weight of up to one-hundred pounds of weight whether said runners or said wheels are attached.

6. A wagon, comprising:
A metal frame, having a rectangular 3-dimensional shape, and having a top opening portion and a bottom portion;
A canvas material removably attached to said metal frame;
A handle attached to one outer side of said top opening portion;
Four legs, being cylindrical metal pieces connected to the four corners of said bottom portion and extending in the opposite direction of the opening of said top portion;
Four runners, being pieces of metal constructed in a flat or slightly upward-curved fashion perpendicularly attached to said legs; and
Said runners include a cylindrical piece of metal independent of said legs, and are removably attached to said legs by spring pin.

7. A wagon as in claim 6, further comprising:
The bottom and long sides of said metal frame being a composition of pieces of metal that extend at diagonal trajectories and connect by circular means of attachment, permitting the sides to compress in an accordion style.

8. A wagon as in claim 6 or 7, wherein the structure of said wagon can support a weight of up to one-hundred pounds of weight whether said runners or said wheels are attached.

9. A wagon, comprising:
A metal frame, having a rectangular 3-dimensional shape, and having a top opening portion and a bottom portion;
A canvas material removably attached to said metal frame;
A handle attached to one outer side of said top opening portion;
Four legs, being cylindrical metal pieces connected to the four corners of said bottom portion and extending in the opposite direction of the opening of said top portion;
Four runners, being pieces of metal constructed in a flat or slightly upward-curved fashion perpendicularly attached to said legs;
Said runners include a cylindrical piece of metal independent of said legs, and are removably attached to said legs by spring pin;
Four wheels that include a cylindrical piece of metal and removably attach to said legs by spring pin; and
The structure of said wagon can support a weight of up to one-hundred pounds of weight whether said runners or said wheels are attached.

10. A wagon as in claim 9, further comprising:
The bottom and long sides of said metal frame being a composition of pieces of metal that extend at diagonal trajectories and connect by circular means of attachment, permitting the sides to compress in an accordion style.
